(19) United States
(12) Patent Application Publication
(10) Pub. No.: US 2019/0047811 A1
(43) Pub. Date: Feb. 14, 2019

(54) PAPER SHEET HANDLING APPARATUS AND PAPER SHEET HANDING METHOD

(71) Applicant: FUJITSU FRONTECH LIMITED, Inagi (JP)

(72) Inventor: Ryosuke EBINUMA, Inagi (JP)

(73) Assignee: FUJITSU FRONTECH LIMITED, Inagi (JP)

(21) Appl. No.: 16/164,433

(22) Filed: Oct. 18, 2018

Related U.S. Application Data
(63) Continuation of application No. PCT/JP2016/063096, filed on Apr. 26, 2016.

(51) Int. Cl. B65H 7/02; B65H 3/04; B65H 5/06; G07D 11/00

(52) U.S. Cl. CPC B65H 7/02; B65H 3/047; B65H 5/06; G07D 2211/00; G07D 11/0021; G07D 11/0036; B65H 2701/1912; G07D 11/0018

(57) ABSTRACT

A paper sheet handling apparatus includes a conveyance path where a paper sheet, which is inserted through an insertion port, is introduced to a feeding position and the paper sheet is fed from the feeding position into an interior of its own apparatus, an introduction mechanism that has a conveyance belt and introduces the paper sheet, which is inserted through the insertion port to the feeding position, a feeding mechanism that feeds the paper sheet, which is delivered to the feeding position by the introduction mechanism, and a controller configured to control the introduction mechanism and the feeding mechanism. The controller controls the feeding mechanism in such a manner that the paper sheet, which is inserted through the insertion port, is fed when the paper sheet is not introduced to the feeding position after the introduction mechanism repeats, a predetermined number of times.

### CROSS-REFERENCE TO RELATED APPLICATION

This application is a continuation application of International Application PCT/JP2016/063096, filed on Apr. 26, 2016 and designating the U.S., the entire contents of which are incorporated herein by reference.

### FIELD

The present invention relates to a paper sheet handling apparatus and a paper sheet handling method.

### BACKGROUND

For example, an automatic telling machine (that will be referred to as an Automated Teller Machine (ATM) below) as a paper sheet handling apparatus includes a deposition unit for depositing a banknote. Such a kind of deposition unit may have an introduction mechanism for introducing a banknote that is inserted through an insertion port to a feeding position, and a feeding mechanism that feeds the banknote, which is introduced by the introduction mechanism, from the feeding position into an interior of an ATM.
Patent Literature 1: Japanese Laid-open Patent Application No. 2002-046871

In a paper sheet handling apparatus as described above, when a degraded banknote or a deformed banknote with a folded corner or the like, is inserted, it may be impossible for an introduction mechanism to introduce the banknote to a feeding position properly. In a paper sheet handling apparatus, in a case where a banknote is not introduced to a feeding position after an introduction mechanism repeats an operation for introducing a banknote to a feeding position multiple times, a feeding mechanism stops such an operation for introducing a banknote.

Herein, a back end side of a banknote that is not introduced by an introduction mechanism in an insertion direction, may be left outside an insertion port. Accordingly, a user may forcibly push a back end of a non-introduced banknote into an interior of an apparatus through an insertion port to cause a jam of the banknote (that will be referred to as a jam below). Therefore, a frequency of maintenance work for a paper sheet handling apparatus may be increased or a failure of an introduction mechanism or the like may be caused, depending on a reaction of a user in a case where a banknote is not introduced by the introduction mechanism.

### SUMMARY

According to an aspect of the embodiments, a paper sheet handling apparatus includes: a conveyance path that has an insertion port with a paper sheet being inserted therethrough, where the paper sheet, which is inserted through the insertion port, is introduced to a feeding position and the paper sheet is fed from the feeding position into an interior of its own apparatus; an introduction mechanism that has a conveyance belt, which is provided on the conveyance path and contacts the paper sheet in a deflecting state thereof to deliver the paper sheet, and introduces the paper sheet, which is inserted through the insertion port to the feeding position; a feeding mechanism that has a first feeding roller, which is provided on the conveyance path and is arranged at the feeding position, and a second feeding roller, which is arranged between the conveyance belt and the feeding position in a conveyance direction for the paper sheet, and feeds the paper sheet, which is delivered to the feeding position by the introduction mechanism; and a controller configured to control the introduction mechanism and the feeding mechanism, wherein the controller controls the feeding mechanism in such a manner that the paper sheet, which is inserted through the insertion port, is fed when the paper sheet is not introduced to the feeding position after the introduction mechanism repeats, a predetermined number of times, an operation for driving the conveyance belt for a predetermined period of time to introduce the paper sheet to the feeding position.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating a banknote handling apparatus according to an embodiment.

FIG. 2 is a cross-sectional view illustrating a banknote handling apparatus according to an embodiment.

FIG. 3 is a plan view illustrating a banknote handling apparatus according to an embodiment.

FIG. 4 is a block diagram illustrating a banknote handling apparatus according to an embodiment.

FIG. 5A is a cross-sectional view illustrating a standby state in a banknote handling apparatus according to an embodiment.

FIG. 5B is a plan view illustrating a standby state in a banknote handling apparatus according to an embodiment.

FIG. 6A is a cross-sectional view illustrating a state where an introduction mechanism introduces a banknote in a banknote handling apparatus according to an embodiment.

FIG. 6B is a plan view illustrating a state where an introduction mechanism introduces a banknote in a banknote handling apparatus according to an embodiment.

FIG. 7A is a cross-sectional view illustrating a state where a banknote is introduced to a feeding position in a banknote handling apparatus according to an embodiment.

FIG. 7B is a plan view illustrating a state where a banknote is introduced to a feeding position in a banknote handling apparatus according to an embodiment.

FIG. 8A is a cross-sectional view illustrating a state where a banknote is fed from a feeding position in a banknote handling apparatus according to an embodiment.

FIG. 8B is a plan view illustrating a state where a banknote is fed from a feeding position in a banknote handling apparatus according to an embodiment.

FIG. 9 is a flowchart for illustrating a process where a feeding mechanism forcibly feeds a banknote in a banknote handling apparatus according to an embodiment.

### DESCRIPTION OF EMBODIMENTS

Hereinafter, an embodiment(s) of a paper sheet handling apparatus and a paper sheet handling method as disclosed in the present application will be described in detail based on the drawing(s). Additionally, a paper sheet handling apparatus and a paper sheet handling method as disclosed in the present application are not limited by the following embodiment(s). Furthermore, an explanation will be executed by using a banknote as an example of a paper sheet.

### EMBODIMENTS

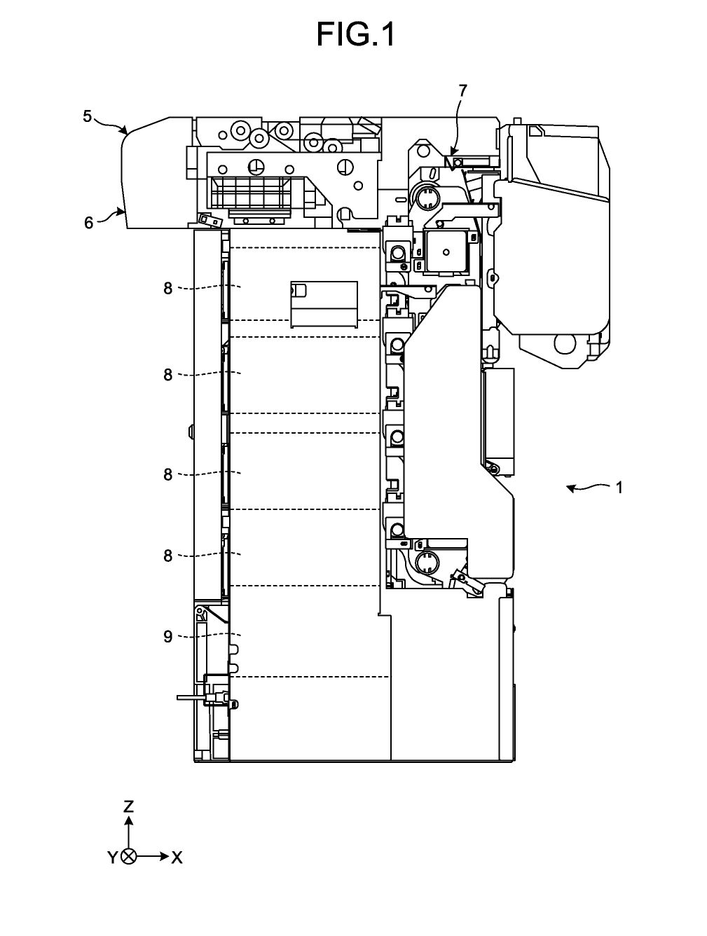

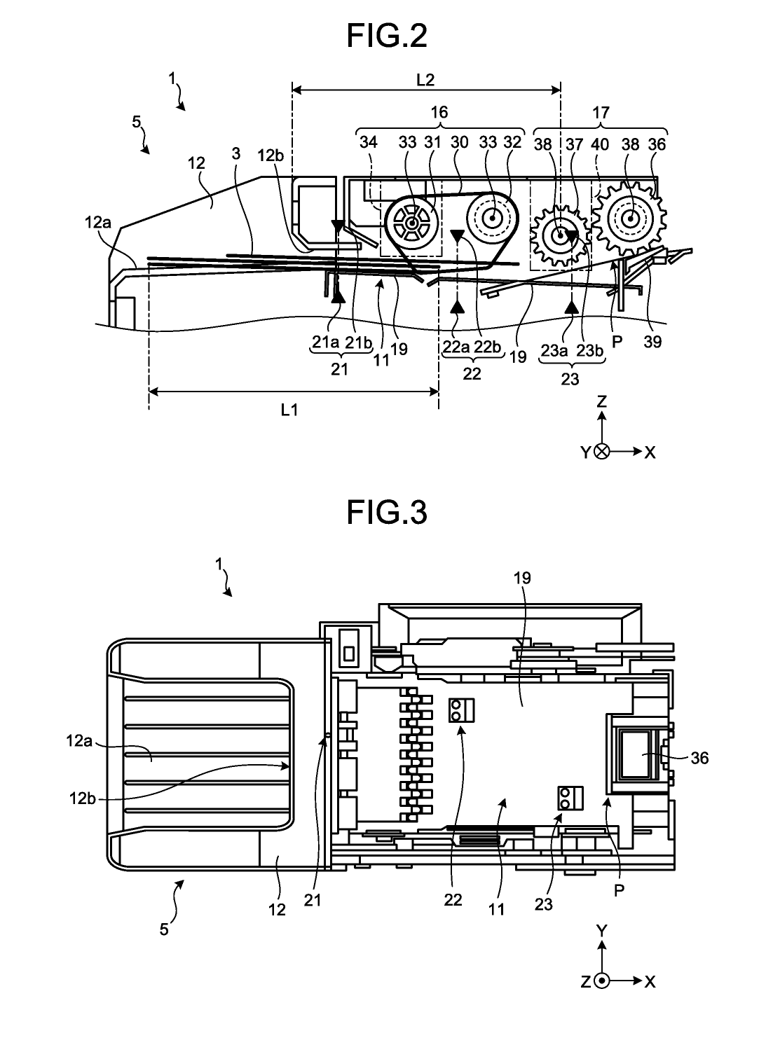

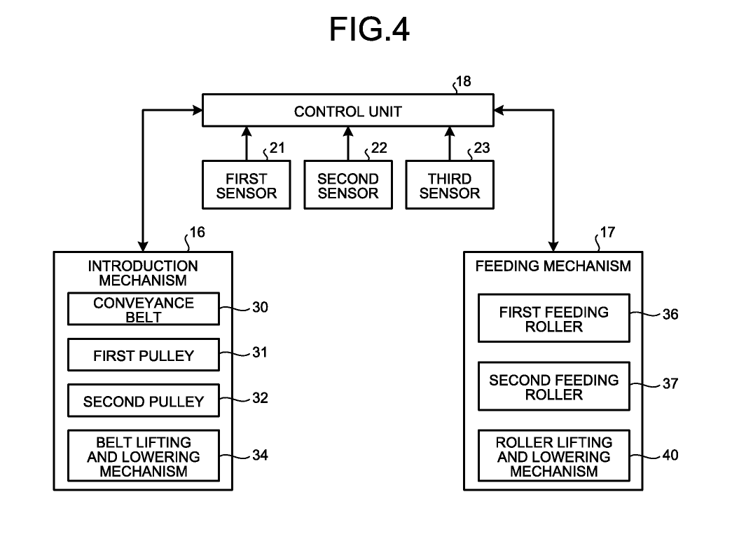

FIG. 1 is a schematic diagram illustrating a banknote handling apparatus according to an embodiment. FIG. 2 is a cross-sectional view illustrating a banknote handling apparatus according to an embodiment. FIG. 3 is a plan view illustrating a banknote handling apparatus according to an embodiment. FIG. 4 is a block diagram illustrating a banknote handling apparatus according to an embodiment.

(Configuration of Banknote Handling Apparatus)

As illustrated in FIG. 1, a banknote handling apparatus 1 according to an embodiment has a deposition unit 5 for depositing a banknote, a withdrawal unit 6 for withdrawing a banknote, a discriminating unit 7 for discriminating a banknote, one or more hold units 8 for temporarily holding a banknote, and a storage unit 9 for storing a banknote. In FIG. 1 or later, a depth direction of the banknote handling apparatus 1 is an X-direction, a width direction of the banknote handling apparatus 1 is a Y-direction, a height direction of the banknote handling apparatus 1 is a Z-direction.

A banknote that is fed into an interior of the banknote handling apparatus 1 by the deposition unit 5 is delivered to, for example, the discriminating unit 7 that discriminates banknotes, the hold units 8, or the like. Additionally, the banknote handling apparatus 1 may be configured to serve as the deposition unit 5 and the withdrawal unit 6.

A banknote also includes a banknote that is composed of, for example, a resin material such as a polymer. Furthermore, although, for example, a banknote is described as an example of a paper sheet in the present embodiment, a banknote handling apparatus according to the present invention is not limited thereto. A paper sheet also includes a check, a cash voucher, a security, a voucher ticket, and another monetarily valuable medium, as well as a paper sheet or note.

As illustrated in FIG. 2 or FIG. 3, the banknote handling apparatus 1 according to an embodiment includes a conveyance path 11 where a banknote 3 that is inserted through an insertion port 12 of the deposition unit 5 in an X-direction is introduced to a feeding position P and the banknote 3 is fed from the feeding position P into an interior of the banknote handling apparatus (its own apparatus) 1.

A tray member 12 for inserting a banknote 3 is provided on an end of the conveyance path 11. The tray member 12 has a mounting surface 12a for mounting a banknote 3 thereon and an insertion port 12b for inserting a bill or mote 3 along the mounting surface 12a. The insertion port 12b of the tray member 12 is formed to be capable of inserting a stack of a plurality of superimposed banknotes 3 therethrough. In the present embodiment, a banknote 3 with a rectangular shape is conveyed in a long side direction of the banknote 3.

Furthermore, a pressure plate 19, which contacts and presses a banknote 3 that is conveyed along the conveyance path 11, is fixed on the conveyance path 11 along the conveyance path 11. The pressure plate 19 supports a banknote 3 that is pressed by a conveyance belt 30 of an introduction mechanism 16 and by first feeding roller 36 and second feeding rollers 37 of a feeding mechanism 17 as described later.

Furthermore, as illustrated in FIG. 2, FIG. 3, and FIG. 4, the banknote handling apparatus 1 includes an introduction mechanism 16 that introduces a banknote 3, which is inserted through the insertion port 12b to the feeding position P, a feeding mechanism 17 that feeds the banknote 3 from the feeding position P, and a control unit 18 that controls the introduction mechanism 16 and the feeding mechanism 17. For example, a control unit that controls the respective units 5 to 9 of the banknote handling apparatus 1, respectively, may serve as the control unit 18.

Furthermore, as illustrated in FIG. 2, FIG. 3, and FIG. 4, the banknote handling apparatus 1 includes a first sensor 21, a second sensor 22, and a third sensor 23 as a plurality of detection units that detect a position of a banknote 3, which is conveyed along the conveyance path 11.

(Introduction Mechanism)

As illustrated in FIG. 2, the introduction mechanism 16 is provided to be adjacent to the insertion port 12b of the tray member 12 and arranged on an upstream side of the feeding mechanism 17 in a conveyance direction for a banknote 3 (X-direction). The introduction mechanism 16 has a conveyance belt 30 that delivers a banknote 3, which is inserted through the insertion port 12b, a first pulley 31 and a second pulley 32 as a plurality of rotational bodies that support the conveyance belt 30 in a deflecting state thereof, which is caused by its own weight, and rotary shafts 33 that support the first pulley 31 and the second pulley 32. Furthermore, the introduction mechanism 16 has a belt lifting and lowering mechanism 34 that lifts and lowers the rotary shaft 33 of the first pulley 31 in a Z-direction, and a non-illustrated driving motor that drives the rotary shaft 33 and the belt lifting and lowering mechanism 34. As illustrated in FIG. 4, the introduction mechanism 16 is connected to the control unit 18 and is driven by the control unit 18 based on a result of detection of the first sensor 21.

In the introduction mechanism 16, a defecting part of the conveyance belt 30 that is supported by the first pulley 31 and the second pulley 32 in a deflecting state of the conveyance belt 30, which is caused by its own weight, contacts a banknote 3, and the banknote 3 is delivered by the deflecting part. Accordingly, the conveyance belt 30, which is rotated, limits a magnitude of conveyance power that is transmitted to a banknote 3, so that excessive conveyance power is prevented from being applied to the banknote 3. Thereby, the introduction mechanism 16 is allowed to deliver only a top sheet of a stack of banknotes 3 (its upper end in a Z-direction) that are inserted through the insertion port 12b, and introduces a banknote 3 to the feeding position P properly. As a result, the feeding mechanism 17 is allowed to feed a banknote 3 that is introduced properly to the feeding position P, and is capable of feeding the banknote 3 into an interior of the banknote handling apparatus 1 properly.

Therefore, the introduction mechanism 16 executes a function of adjusting a position of a front end of a stack of banknotes 3 that are inserted through the insertion port 12b, in an insertion direction. In a banknote handling apparatus that does not include the introduction mechanism 16, in a case where a stack of a plurality of banknotes 3, which include multiple types of banknotes 3, is inserted through the insertion port 12b, the feeding mechanism 17 may feed a banknote at a middle of such a stack of banknotes 3 or feed a plurality of superimposed banknotes 3 (execute multiple delivery) due to a position of a front end of such a stack of banknotes 3 that is not adjusted in an insertion direction. On the other hand, in the present embodiment, a stack of a plurality of inserted banknotes 3 is introduced by the conveyance belt 30 of the introduction mechanism 16 on an upstream side of the feeding mechanism 17 in a conveyance direction for a banknote 3, and thereby, introduced to a predetermined feeding position P in a state where front ends of such a plurality of banknotes 3 are adjusted. Thereby, the feeding mechanism 17 is capable of feeding only a top sheet of a stack of banknotes 3 (its upper end in a Z-direction) properly.

(Feeding Mechanism)

As illustrated in FIG. 2, the feeding mechanism 17 has a first feeding roller (main roller) 36 and a second feeding roller (sub-roller) 37 that feed a banknote 3, which is delivered to the feeding position P by the introduction mechanism 16, and rotary shafts 38 that support the first feeding roller 36 and the second feeding roller 37. Furthermore, the feeding mechanism 17 has a separator 39 for separating and delivering banknotes 3 from the feeding position P one by one, a roller lifting and lowering mechanism 40 that lifts and lowers the second feeding roller 37, and a non-illustrated driving motor that drives the first feeding roller 36, second feeding roller 37 and the roller lifting and lowering mechanism 40.

The first feeding roller 36 is arranged at the feeding position P. The second feeding roller 37 is arranged between the conveyance belt 30 and the first feeding roller 36 in a conveyance direction for a banknote 3. The separator 39 is arranged to face the first feeding roller 36 and contacts the first feeding roller 36.

The feeding position P is a position where the first feeding roller 36 is capable of feeding a banknote 3, and refers to, for example, a position where a front end of a banknote 3, which is introduced by the introduction mechanism 16, is delivered until it contacts the first feeding roller 36 and the separator 39 therebetween.

Furthermore, as illustrated in FIG. 4, the feeding mechanism 17 is connected to the control unit 18 and driven by the control unit 18 based on a result of detection of the second sensor 22.

Furthermore, as illustrated in FIG. 2, the feeding mechanism 17 is provided in such a manner that a distance L2 between a position, where the second feeding roller 37 contacts a banknote 3 (that is provided on an extension of a center of the rotary shaft 38 thereof), and the insertion port 12b in a conveyance direction for a banknote 3, is set to be less than a length L1 of a banknote in the conveyance direction. Accordingly, in a state where a back end of a banknote 3 that is inserted through the insertion port 12b protrudes from the insertion port 12b to an exterior, a front end of the banknote 3 contacts the second feeding roller 37, so that the banknote 3, which is not introduced to the feeding position P by the introduction mechanism 16, is allowed to be fed from a front of the feeding position P on the conveyance path 11.

Therefore, even in a case where it is not possible to introduce a banknote 3 to the feeding position P, the second feeding roller 37 of the feeding mechanism 17 is arranged at a position where it contacts a front end side of a banknote 3 that is introduced by the conveyance belt 30, and arranged on an insertion port 12b side of the feeding position P, so that it is possible to introduce a banknote 3, which is inserted through the insertion port 12b, and feed the banknote 3.

(First, Second, and Third Sensors)

The first sensor 21 is arranged near the insertion port 12b and detects a banknote 3 that is inserted through the insertion port 12b. The first sensor 21 has a light-emitting unit 21a that emits detection light for detecting a banknote 3, and a light-receiving unit 21b that receives detection light that is emitted from the light-emitting unit 21a. The light-emitting unit 21a and the light-receiving unit 21b are oppositely provided to interpose the conveyance path 11 therebetween.

The second sensor 22 is arranged at a position that is adjacent to a deflecting part of the conveyance belt 30 of the introduction mechanism 16 in a conveyance direction for a banknote 3, and detects a banknote 3 that is delivered by the introduction mechanism 16. The second sensor 22 has a light-emitting unit 22a that emits detection light for detecting a banknote 3, and a light-receiving unit 22b that receives detection light that is emitted from the light-emitting unit 22a, similarly to the first sensor 21. The light-emitting unit 22a and the light-receiving unit 22b are oppositely provided to interpose the conveyance path 11 therebetween.

The third sensor 23 is arranged at the feeding position P to be adjacent to the second feeding roller 37 in a conveyance direction for a banknote 3, and detects a banknote 3 that is introduced to the feeding position P. The third sensor 23 has a light-emitting unit 23a that emits detection light for detecting a banknote 3, and a light-receiving unit 23b that receives detection light that is emitted from the light-emitting unit 23a. The light-emitting unit 23a and the light-receiving unit 23b are oppositely provided to interpose the conveyance path 11 therebetween.

As illustrated in FIG. 3, the first sensor 21, the second sensor 22, and the third sensor 23 are arranged at mutually different positions in a width direction for a banknote 3 that is conveyed (Y-direction). Furthermore, as illustrated in FIG. 4, the first sensor 21, the second sensor 22, and the third sensor 23 are connected to the control unit 18 and transmit respective detection signals to the control unit 18.

When the first sensor 21 detects a banknote 3, the control unit 18 determines that a banknote 3 is inserted through the insertion port 12b. Herein, the control unit 18 drives the conveyance belt 30 of the introduction mechanism 16 and lowers a deflecting part of the conveyance belt 30 to the conveyance path 11 to execute an operation for introducing a banknote 3 by the conveyance belt 30. When the second sensor 22 detects a banknote 3, the control unit 18 determines that a banknote 3 is delivered by the conveyance belt 30 of the introduction mechanism 16. Herein, the control unit 18 drives the second feeding roller 37 of the feeding mechanism 17 and lowers the second feeding roller 37 to the conveyance path 11 to execute an operation for feeding a banknote 3 by the second feeding roller 37. When the third sensor 23 detects a banknote 3, the control unit 18 determines that a banknote 3 is fed to the feeding position P by the second feeding roller 37. Herein, the control unit 18 drives the first feeding roller 36 and feeds a banknote 3 that is separated by the first feeding roller 36 and the separator 39 one by one into an interior of the banknote handling apparatus 1.

Furthermore, in a case where none of the first, second, and third sensors 21, 22, and 23 detects a banknote 3, the banknote handling apparatus 1 according to an embodiment does not execute an operation for introducing and an operation for feeding a banknote 3 while determining that a banknote under an exception for handling or another paper sheet is inserted.

Additionally, on the conveyance path 11, another sensor, which detects a banknote 3, may be further provided, for example, between the second sensor 22 and the third sensor 23 in a conveyance direction for a banknote 3, as needed. Furthermore, the first sensor 21, the second sensor 22, and the third sensor 23 are not limited to optical sensors, and for example, another sensor such as an ultrasonic sensor or an image sensor, may be used.

(Operation for Handling Banknote)

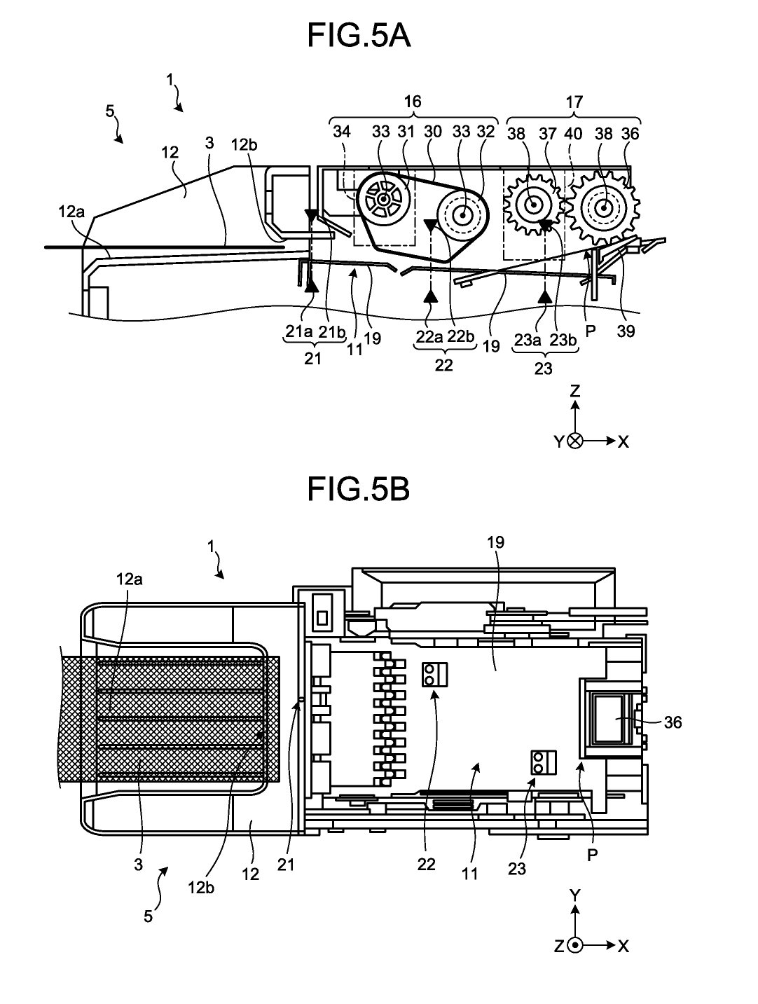

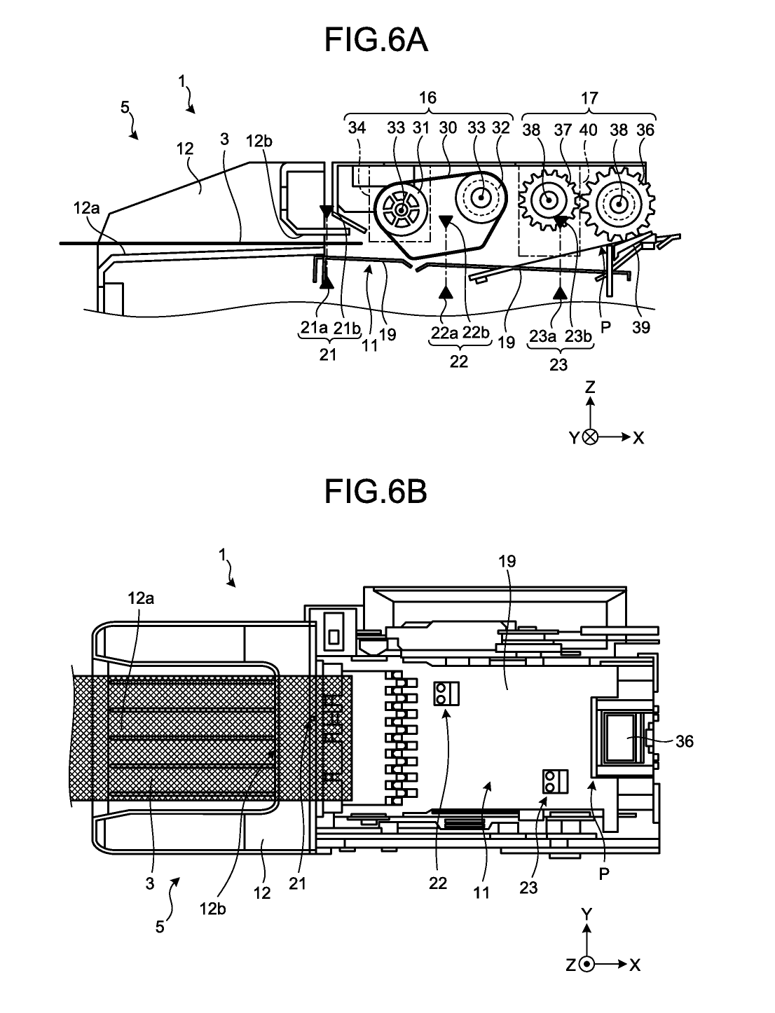

An operation for handling a banknote 3 in the banknote handling apparatus 1 configured as described above will be described with reference to the drawings. FIG. 5A is a cross-sectional view illustrating a standby state in the banknote handling apparatus 1 according to an embodiment. FIG. 5B is a plan view illustrating a standby state in the banknote handling apparatus 1 according to an embodiment. FIG. 6A is a cross-sectional view illustrating a state where the introduction mechanism 16 introduces a banknote 3 in the banknote handling apparatus 1 according to an embodiment. FIG. 6B is a plan view illustrating a state where the introduction mechanism 16 introduces a banknote 3 in the banknote handling apparatus 1 according to an embodiment.

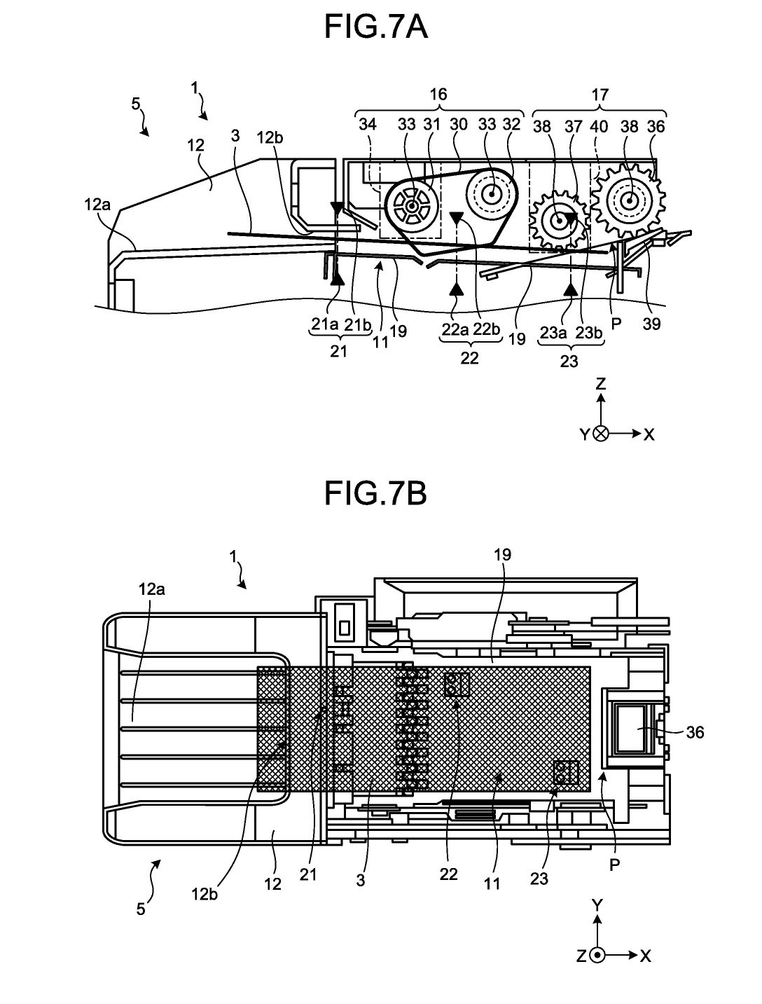

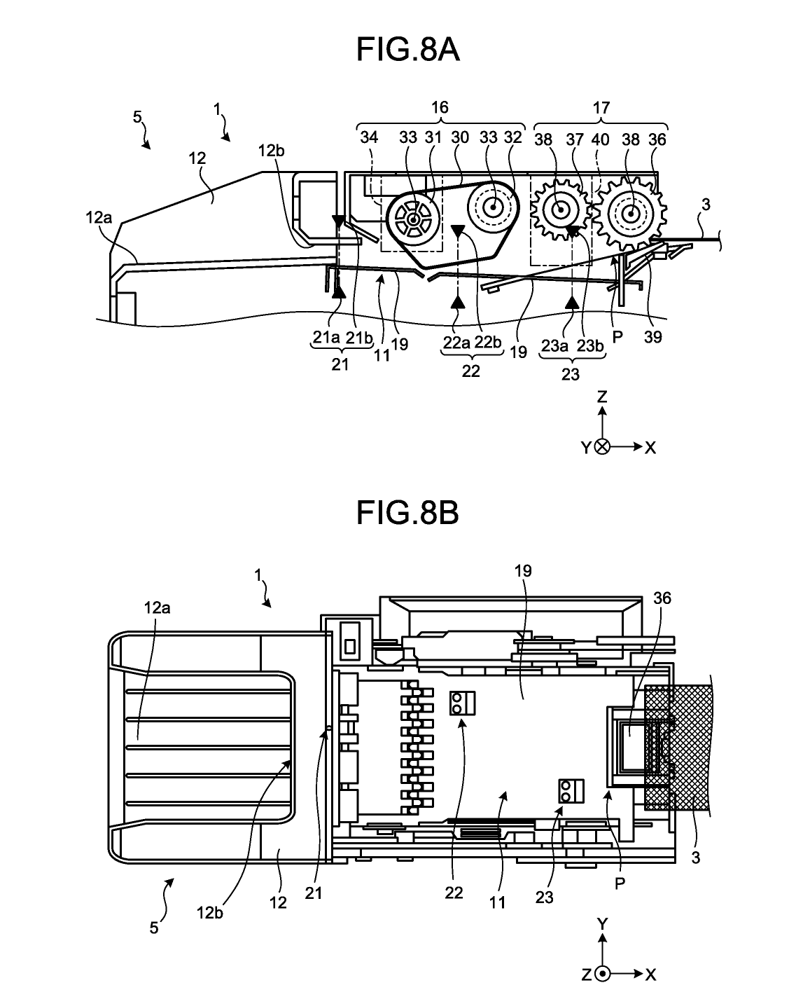

FIG. 7A is a cross-sectional view illustrating a state where a banknote 3 is introduced to the feeding position P in the banknote handling apparatus 1 according to an embodiment. FIG. 7B is a plan view illustrating a state where a banknote 3 is introduced to the feeding position P in the banknote handling apparatus 1 according to an embodiment. FIG. 8A is a cross-sectional view illustrating a state where a banknote 3 is fed from the feeding position P in the banknote handling apparatus 1 according to an embodiment. FIG. 8B is a plan view illustrating a state where a banknote 3 is fed from the feeding position P in the banknote handling apparatus 1 according to an embodiment.

As illustrated in FIG. 5A and FIG. 5B, in the banknote handling apparatus 1, the conveyance belt 30 of the introduction mechanism 16 is moved upward from the conveyance path 11 before a banknote 3 is inserted through the insertion port 12b. Furthermore, the second feeding roller 37 of the feeding mechanism 17 is moved upward from the conveyance path 11.

As illustrated in FIG. 6A and FIG. 6B, in the banknote handling apparatus 1, when a banknote 3 is inserted through the insertion port 12b, a front end of the banknote 3 in a conveyance direction reaches the first sensor 21, so that the banknote 3 is detected by the first sensor 21. When the first sensor 21 detects a banknote 3, the control unit 18 controls the introduction mechanism 16 so that the first pulley 31 is lowered by the belt lifting and lowering mechanism 34, and thereby a deflecting part of the conveyance belt 30 contacts the banknote 3, which is inserted along the conveyance path 11. The control unit 18 controls the introduction mechanism 16 so that a banknote 3 is introduced to the feeding position P by the conveyance belt 30.

Then, as illustrated in FIG. 7A and FIG. 7B, in the banknote handling apparatus 1, a front end of a banknote 3 that is delivered by the conveyance belt 30 of the introduction mechanism 16, reaches the second sensor 22, so that the banknote 3 is detected by the second sensor 22. When the second sensor 22 detects a banknote 3, the control unit 18 controls the feeding mechanism 17 so that the second feeding roller 37 is lowered by the roller lifting and lowering mechanism 40, and thereby the second feeding roller 37 contacts the banknote 3, which is delivered along the conveyance path 11 by the introduction mechanism 16. The control unit 18 controls the feeding mechanism 17 so that a banknote 3 is fed by the second feeding roller 37. Herein, a front end of a banknote 3 that is fed by the second feeding roller 37, reaches the third sensor 23, so that the banknote 3 is detected by the third sensor 23.

When the third sensor 23 detects a banknote 3, the control unit 18 controls the feeding mechanism 17 to drive the first feeding roller 36. A banknote 3 that is delivered to the feeding position P by the second feeding roller 37, moves to intervene between the first feeding roller 36 and the separator 39, then is separated by the first feeding roller 36 and the separator 39 one by one, and is fed into an interior of the banknote handling apparatus 1 by the first feeding roller 36 as illustrated in FIG. 8A and FIG. 8B. After the first feeding roller 36 feeds a banknote 3, the control unit 18 controls the roller lifting and lowering mechanism 40 of the feeding mechanism 17 so that the second feeding roller 37 is moved upward from the conveyance path 11.

(Process for Forcibly Feeding Banknote)

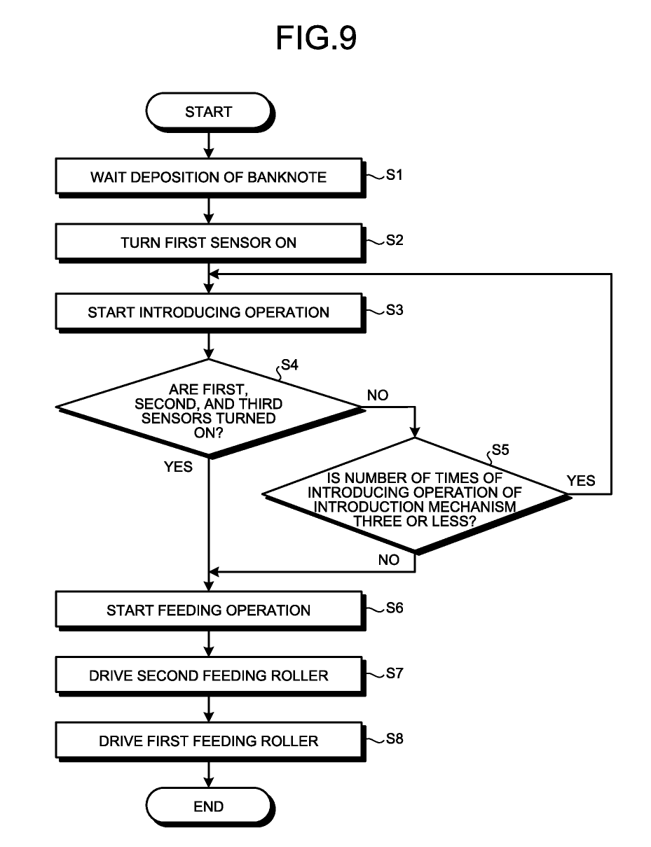

FIG. 9 is a flowchart for illustrating a process where the feeding mechanism 17 forcibly feeds a banknote 3 in the banknote handling apparatus 1 according to an embodiment.

As illustrated in FIG. 9, before a user inserts a banknote 3 through the insertion port 12b, the banknote handling apparatus 1 is in a standby state or a so-called deposition waiting state for a banknote 3 (step S1). When a user inserts a banknote 3 through the insertion port 12b, the banknote handling apparatus 1 is in a state where the first sensor 21 detects the banknote 3 (ON condition) (step S2). When the first sensor 21 is in an ON condition, the control unit 18 controls the introduction mechanism 16 so that the conveyance belt 30 starts an operation for introducing a banknote 3, which is inserted through the insertion port 12b (step S3).

Then, after starting an operation for introducing a banknote 3, the control unit 18 determines whether or not the first sensor 21, the second sensor 22, and the third sensor 23 are all in an ON condition (step S4). At step S4, in a case where it is determined that the first sensor 21, the second sensor 22, and the third sensor 23 are not all in an ON condition, the control unit 18 determines whether or not a number of times of an operation of the introduction mechanism 16 to introduce a banknote 3, is three or less (step S5).

In an operation of the introduction mechanism 16 to introduce a banknote 3, the conveyance belt 30 is driven for a predetermined period of time, for example, approximately several seconds to provide a state where a banknote 3 is introduced to the feeding position P and the third sensor 23 detects the banknote 3 (ON condition). Thus, the conveyance belt 30 is driven for a predetermined period of time, so that it is assumed that one introducing operation is executed.

At step S5, in a case where it is determined that a number of times of an operation for introducing a banknote 3, is three or less, the control unit 18 assumes that there is a possibility of introducing a banknote 3 and returns to step S3 to start such an introducing operation again. At step S5, in a case where it is determined that a number of times of an operation for introducing a banknote 3, is not three or less, that is, in a case where it is determined that a number of times of such an introducing operation, is four, the control unit 18 assumes that it is not possible to introduce a banknote 3 and transfers to step S6 to control the feeding mechanism 7 and thereby feed a banknote 3 forcibly.

Furthermore, at step S4, in a case where it is determined that the first sensor 21, the second sensor 22, and the third sensor 23 are all in an ON condition, the control unit 18 controls the feeding mechanism 17 to start an operation for feeding a banknote 3 that is introduced to the feeding position P (step S6). The control unit 18 drives the second feeding roller 37 to feed a banknote 3 that is delivered by the conveyance belt 30 (step S7). Subsequently, the control unit 18 drives the first feeding roller 36, so that a banknote 3, which is fed by the second feeding roller 37, is fed into an interior of the banknote handling apparatus 1 while being separated by the first feeding roller 36 and the separator 39 one by one (step S8).

Furthermore, although the present embodiment executes control in such a manner that the feeding mechanism 17 executes an operation for forcibly feeding a banknote 3 after the introduction mechanism 16 repeats an operation for introducing a banknote 3 three times, a number of times that such an introducing operation is repeated, is not limited.

For example, in a case where conveyance is executed in a state where a corner of a front end of a banknote 3 in a conveyance direction, is folded, the third sensor 23, which corresponds to such a corner, is not necessarily be in an ON condition. Such a case is in a state where a banknote 3 is substantially introduced to the feeding position P, and the feeding mechanism 17 is capable of feeding the banknote 3. In such a case, in a conventional operation, the third sensor 23 is not in an ON condition, so that the introduction mechanism 16 stops an operation for introducing a banknote 3, and a banknote 3 stays on the conveyance path 11. Herein, when a user forcibly pushes a banknote 3 into the insertion port 12b, occurrence of a jam of the banknote 3, a failure of the introduction mechanism 16 or the feeding mechanism 17, or the like, is caused. According to an embodiment, it is possible to prevent an ATM with the banknote handling apparatus 1 incorporated therein from being stopped in order to execute maintenance work that is caused by such a jam and a failure.

Furthermore, in a case where a banknote 3 is forcibly fed by the feeding mechanism 17, the control unit 18 may execute control in such a manner that a rotational speed of each of the first feeding roller 36 and the second feeding roller 37 is stepwise reduced depending on a number of times that the introduction mechanism 16 executes an operation for introducing a banknote 3.

Specifically, when a banknote 3 is not introduced to the feeding position P by the introduction mechanism 16, the control unit 18 controls the feeding mechanism 17 in such a manner that the first feeding roller 36 and the second feeding roller 37 are rotated at a second rotational speed that is less than a first rotational speed at a time when a banknote 3, which is introduced to the feeding position P, is fed. Thereby, it is assumed that a banknote 3, which is not allowed to be introduced smoothly, is, for example, a case where a user holds a back end side of an inserted banknote 3 with his or her hand, or a banknote 3 is degraded or deformed, and the banknote 3 is fed relatively slowly, so that it is possible to prevent occurrence of a damage, a breakage, or a jam of the banknote 3.

In addition, in a case where a banknote 3 is forcibly fed by the feeding mechanism 17 after an operation for introducing a banknote 3 is repeated a predetermined number of times in a state where at least one of the first sensor 21, the second sensor 22, and the third sensor 23 does not detect a banknote 3 (OFF condition), the control unit 18 controls the feeding mechanism 17 in such a manner that the first feeding roller 36 and the second feeding roller 37 are rotated at a third rotational speed, which is less than the second rotational speed. Thereby, it is assumed that a banknote 3, which is not allowed to be introduced smoothly, is a banknote 3, which has a high possibility of causing further degradation or deformation thereof, and the banknote 3 is fed relatively further smoothly, so that it is possible to prevent occurrence of a damage, a breakage, or a jam of the banknote 3.

For example, for the first rotational speed (high speed), a number of rotations per minute is set at approximately 300 rpm (where a pulse speed of a driving motor is 1000 pps). For the second rotational speed (middle speed), a number of rotations is set at approximately 250 rpm (where a pulse speed is 833 pps). For the third rotational speed (low speed), a number of rotations is set at approximately 188 rpm (where a pulse speed is 625 pps).

Furthermore, in a case where the introduction mechanism 16 repeats, a predetermined number of times, an operation for introducing a banknote 3 to the feeding position P, that is, when a number of times of an operation for introducing a banknote 3 is two, the control unit 18 controls the introduction mechanism 16 in such a manner that a feed speed of the conveyance belt 30 is less than a feed speed at a time when a banknote 3 is first delivered. Thereby, it is assumed that a banknote 3, which is not allowed to be introduced smoothly, is a degraded or deformed banknote 3, and the banknote 3 is introduced relatively slowly, so that it is possible to prevent occurrence of a damage, a breakage, or a jam of the banknote 3 when the banknote 3 is introduced to the feeding position P.

Furthermore, the control unit 18 may determine whether or not a banknote 3 is fed into an interior of the banknote handling apparatus 1 when an operation for forcibly feeding a banknote 3 is executed based on a result of detection of another sensor that detects a banknote 3, which is fed into an interior of the banknote handling apparatus 1 by the first feeding roller 36. For example, in a case where a banknote 3 is not fed into an interior of the banknote handling apparatus 1, the control unit 18 executes control in such a manner that the conveyance belt 30 of the introduction mechanism 16 and the second feeding roller 37 are reversed to execute an operation for forcibly ejecting a banknote 3, which stays on the conveyance path 11, through the insertion port 12b, subsequently to an operation for forcibly introducing a banknote 3.

(Banknote Handling Method)

A banknote handling method that uses the banknote handling apparatus 1 as described above, will be described. In a banknote handling method according to an embodiment, a banknote 3, which is inserted through the insertion port 12b, is introduced to the feeding position P by the conveyance belt 30 that contacts the banknote 3 in a deflecting state thereof and is supported and rotated by the first and second pulleys 31 and 32. Furthermore, in a banknote handling method, a banknote 3, which is delivered to the feeding position P, is fed from the feeding position P by the first feeding roller 36, which is arranged at the feeding position P, and by the second feeding roller 37, which is arranged between the conveyance belt 30 and the feeding position P in a conveyance direction for a banknote 3. Then, in a banknote handling method, when a banknote 3 is not introduced to the feeding position P, after an operation for introducing a banknote 3 to the feeding position P is repeated by the conveyance belt 30 a predetermined number of times, a banknote 3, which is inserted through the insertion port 12b, is forcibly fed by the first feeding roller 36 and the second feeding roller 37.

As a result of comparison between a practical example where a banknote 3, which was not capable of being introduced to the feeding position P, is forcibly fed and a comparative example where, when a banknote 3 was not capable of being introduced to the feeding position P, an introducing operation was not executed but stopping was executed, will be described. For a case where a banknote 3 that included a crumpled and shabby or degradation state and a deformation state with a part of a corner or the like being folded, was inserted as a banknote 3, a result of an experiment according to the present embodiment and a result of an experiment according to a conventional technique, were compared.

(1) Frequency of Occurrence of Inability to Feed and Inability to Eject a Banknote 3

In a result of an experiment according to a conventional technique, a state where forty 3 among fifty banknotes 3 could not be fed and could not be ejected from the conveyance path 11, was caused, and conveyance of the banknotes 3 was stopped. On the other hand, in a result of an experiment according to the present embodiment, only three banknotes 3 among fifty banknotes 3 were incapable of being fed and incapable of being ejected, so that a frequency of occurrence of stopping could be reduced.

(2) Frequency of Occurrence of a Jam of a Banknote

In a result of an experiment according to a conventional technique, twenty six banknotes 3 among fifty banknotes 3 were jammed on the conveyance path 11 and conveyance of the banknotes 3 was stopped. On the other hand, in a result of an experiment according to the present embodiment, only two banknotes 3 among fifty banknotes 3 were jammed on the conveyance path 11, so that a frequency of occurrence of a jam could be reduced.

As described above, the banknote handling apparatus 1 according to the present embodiment includes the feeding mechanism 17 that has the first feeding roller 36, which is arranged at the feeding position P, and the second feeding roller 37, which is arranged between the conveyance belt 30 and the feeding position P in a conveyance direction for a banknote 3, and the control unit 18, which controls the feeding mechanism 17. Furthermore, the control unit 18 of the banknote handling apparatus 1 controls the feeding mechanism 17 in such a manner that a banknote 3, which is inserted through the insertion port 12b, is fed forcibly when the banknote 3 is not introduced to the feeding position P after the introduction mechanism 16 repeats, a predetermined number of times, an operation for introducing a banknote 3 to the feeding position.

Thereby, it is possible for the second feeding roller 37 to feed a banknote 3, which is not allowed to be introduced by the introduction mechanism 16. Thereby, it is possible to prevent a banknote 3, which is not introduced by the introduction mechanism 16, from staying at the insertion port 12b or on the conveyance path 11, and it is possible to prevent occurrence of a breakage, a damage, or a jam of a banknote 3 at a time of introduction of the banknote 3. Therefore, it is possible to reduce a frequency of execution of maintenance work for the banknote handling apparatus 1 and prevent stopping of an ATM with the banknote handling apparatus 1 being installed therein. Furthermore, the feeding mechanism 17 has the second feeding roller 37, so that it is possible to stabilize an operation for feeding a banknote 3 and improve reliability of such a feeding operation.

Furthermore, when a banknote 3 is not introduced to the feeding position P, the control unit 18 of the banknote handling apparatus 1 controls the first feeding roller 36 and the second feeding roller 37 so as to rotate at a second rotational speed that is less than a first rotational speed at a time when a banknote 3, which is introduced to the feeding position P, is fed. Thereby, a banknote 3, which is not allowed to be introduced smoothly, is fed relatively slowly, so that it is possible to prevent occurrence of a damage, a breakage, or a jam of the banknote 3.

Furthermore, in a case where a banknote 3 is fed forcibly in a state where at least one of the first sensor 21, the second sensor 22, and the third sensor 23 does not detect a banknote 3, the control unit 18 of the banknote handling apparatus 1 controls the first feeding roller 36 and the second feeding roller 37 so as to rotate at a third rotational speed that is less than the second rotational speed. Thereby, a banknote 3, which is not allowed to be introduced smoothly, is fed relatively further slowly, so that it is possible to prevent occurrence of a damage, a breakage, or a jam of the banknote 3.

Furthermore, in a case where the introduction mechanism 16 repeats, a predetermined number of times, an operation for introducing a banknote 3 to the feeding position P, the control unit 18 of the banknote handling apparatus 1 executes control to reduce a feed speed of the conveyance belt 30. Thereby, a banknote 3, which is not allowed to be introduced smoothly, is fed relatively slowly, so that it is possible to prevent occurrence of a damage, a breakage, or a jam of a banknote 3 that is introduced to the feeding position P.

According to an aspect of a paper sheet handling apparatus as disclosed in the present application, it is possible to prevent a jam from being caused at a time of introduction of a paper sheet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A paper sheet handling apparatus, comprising:
a conveyance path that has an insertion port with a paper sheet being inserted therethrough, where the paper sheet, which is inserted through the insertion port, is introduced to a feeding position and the paper sheet is fed from the feeding position into an interior of its own apparatus;
an introduction mechanism that has a conveyance belt, which is provided on the conveyance path and contacts the paper sheet in a deflecting state thereof to deliver the paper sheet, and introduces the paper sheet, which is inserted through the insertion port to the feeding position;
a feeding mechanism that has a first feeding roller, which is provided on the conveyance path and is arranged at the feeding position, and a second feeding roller, which is arranged between the conveyance belt and the feeding position in a conveyance direction for the paper sheet, and feeds the paper sheet, which is delivered to the feeding position by the introduction mechanism; and
a controller configured to control the introduction mechanism and the feeding mechanism, wherein
the controller controls the feeding mechanism in such a manner that the paper sheet, which is inserted through the insertion port, is fed when the paper sheet is not introduced to the feeding position after the introduction mechanism repeats, a predetermined number of times, an operation for driving the conveyance belt for a predetermined period of time to introduce the paper sheet to the feeding position.

2. The paper sheet handling apparatus according to claim 1, wherein the controller controls the feeding mechanism in such a manner that the first feeding roller and the second feeding roller are rotated at a second rotational speed that is less than a first rotational speed at a time when the paper sheet, which is introduced to the feeding position, is fed, when the paper sheet is not introduced to the feeding position by the introduction mechanism.

3. The paper sheet handling apparatus according to claim 2, further comprising:
a plurality of detectors that detect a position of the paper sheet, which is conveyed along the conveyance path, wherein
the plurality of detectors include a first detector that detects the paper sheet, which is inserted through the insertion port, a second detector that detects the paper sheet, which is delivered by the introduction mechanism, and a third detector that detects the paper sheet, which is introduced to the feeding position, and
the controller controls the feeding mechanism in such a manner that the first feeding roller and the second feeding roller are rotated at a third rotational speed that is less than the second rotational speed in a case where the paper sheet is fed after the introducing operation is repeated a predetermined number of times in a state where at least one of the first detector, the second detector, and the third detector does not detect the paper sheet.

4. The paper sheet handling apparatus according to claim 1, wherein the controller controls the introduction mechanism in such a manner that a feed speed of the conveyance belt is reduced in a case where the introduction mechanism repeats, a predetermined number of times, an operation for introducing the paper sheet to the feeding position.

5. A paper sheet handling method, wherein:
introducing a paper sheet, which is inserted through an insertion port, to a feeding position by a conveyance belt, which contacts the paper sheet in a deflecting state thereof;
feeding the paper sheet, which is delivered to the feeding position, from the feeding position by a first feeding roller, which is arranged at the feeding position, and a second feeding roller, which is arranged between the conveyance belt and the feeding position in a conveyance direction for the paper sheet; and
feeding the paper sheet, which is inserted through the insertion port, by the first feeding roller and the second feeding roller when the paper sheet is not introduced to the feeding position after an operation for driving the conveyance belt for a predetermined period of time to introduce the paper sheet to the feeding position is repeated a predetermined number of times.
